(19) United States
(12) Patent Application Publication
(10) Pub. No.: US 2012/0003605 A1
(43) Pub. Date: Jan. 5, 2012

(54) ENDODONTIC DIAGNOSTIC INSTRUMENT

(76) Inventors: James B. Johnsen, Beaverton, OR (US); Hal J. Oien, Tualatin, OR (US)

(21) Appl. No.: 12/905,662

(22) Filed: Oct. 15, 2010

Related U.S. Application Data
(60) Provisional application No. 61/252,622, filed on Oct. 16, 2009.

(51) Int. Cl. A61C 19/04

(52) U.S. Cl. 433/81

(57) ABSTRACT

An endodontic diagnostic instrument includes a handle configured for receiving a clamp or retainer which engages and clamps an applicator, which may be made of open-celled foam and which is saturated with a coolant or refrigerant. By utilizing the instrument, a doctor may place or selectively position the applicator against a tooth or multiple teeth to determine the tooth which generates pain.

### BACKGROUND OF THE INVENTION

The present invention relates to endodontics, and more particularly, to an endodontic diagnostic instrument for use in determining which specific tooth or teeth cause pain to a patient. The pain may be generated by numerous causes, such as an inflamed nerve in the pulp of the tooth, an exposed root surface or decay. A patient may complain of bite sensitivity or to sensitivity or pain due to cold and/or heat. Conventional diagnosis may utilize coolant material for contacting a tooth to determine which tooth is the one which is the situs of the pain. Previously, traditional techniques utilizing cold, contemplate using a ball of cotton, which is held by cotton pliers or tweezers, which is saturated with some type of refrigerant. Other methods may utilize dry ice to determine the tooth which is causing the patient's pain.

The present invention is directed to a hand-held endodontic instrument specially adapted to cold test a tooth or multiple teeth in a controlled application and sequence. To this end, the present invention utilizes a handle which is configured for receiving a clamp or retainer which in turn engages and clamps an applicator, which may be made of open-cell foam, which in turn is saturated with a refrigerant. By utilizing the instrument as described, a doctor may place or selectively position the applicator against a tooth or multiple teeth to determine the tooth which generates the pain.

### BRIEF DESCRIPTION OF THE DRAWINGS

FIG. 1 is a view showing the instrument, including its handle, detachable retainer and applicator, prior to a dental coolant being applied to the applicator to chill the applicator.

FIG. 2 is a view, enlarged from that of FIG. 1, showing the retainer, in its folded out, extended position, prior to clamping onto an applicator.

FIG. 2A is a view of the retainer of FIG. 2, showing it being folded or pivoted into its deployed position prior to insertion in the holder.

FIG. 3 is a view, enlarged from that of FIG. 1, showing the applicator, in a folded position, just prior to insertion in the holder.

FIG. 4 is a view, enlarged from that of FIG. 1, showing the applicator, in a folded position, being inserted in the holder.

FIG. 5 is a perspective view of the applicator.

FIG. 6 is a side view, similar to FIG. 4, showing the applicator, inserted into the holder, and being opened to permit insertion of the applicator.

FIG. 7 is a view similar to FIG. 6 showing the retainer clamped onto the applicator to hold it in position.

FIGS. 8-12 show use of the instrument in locating a patient's tooth which is causing pain.

### DETAILED DESCRIPTION OF THE PREFERRED EMBODIMENT

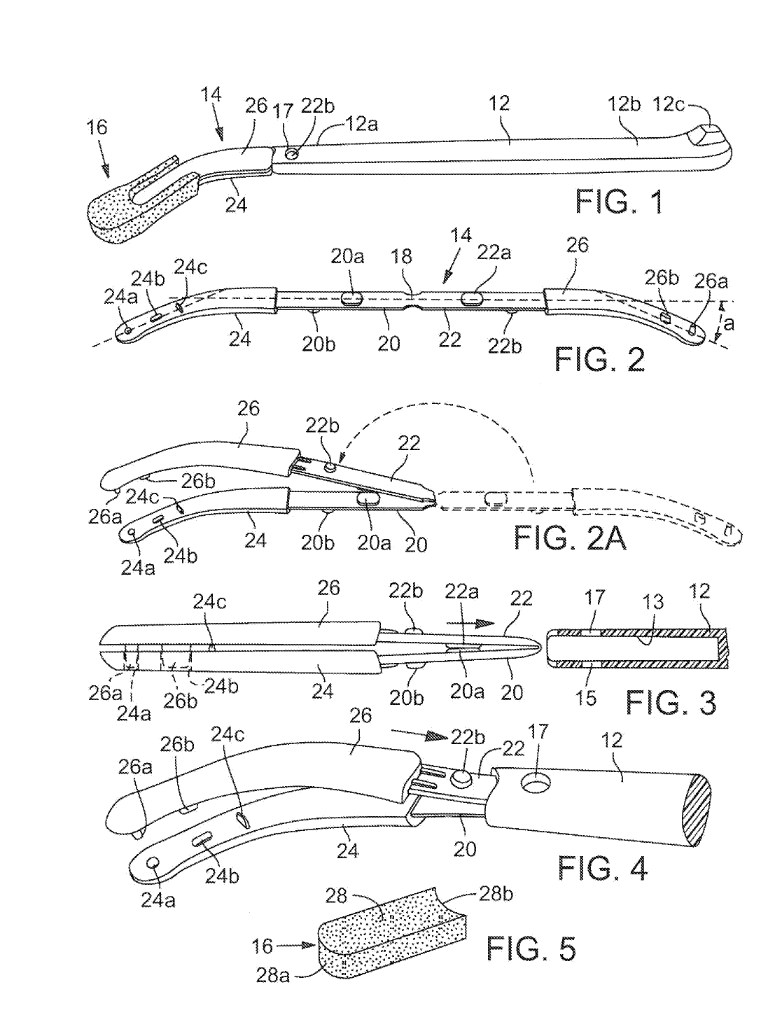

As shown in FIG. 1, an endodontic tool or instrument in accordance with the present invention is generally indicated at 10, and includes a handle 12, a detachable retainer 14, and an applicator indicated at 16. FIG. 1 shows the instrument with its components, namely, handle 12, retainer 14, and applicator 16, fully assembled. The instrument as shown is ready for a coolant to be applied to the applicator so that a doctor may position the applicator tip against a tooth or teeth to determine which is the situs of a patient's pain. The actual assembly, and a description of the components of the instrument will now be described.

The holder of instrument 12 is dimensioned with a length for being comfortably held by a doctor, and includes a neck indicated at 12a and a wider or flared end 12b which further includes an extension 12c provided for fracture testing of a tooth. It will be noted that holder 12 also includes a hollow portion extending from its front inwardly from the holder proper, for receiving retainer 14, in a manner to be described. As shown in FIG. 2, retainer 14 is an elongate member, which may be dimensioned generally in the range of about 4-5 inches, which includes a central notched portion or neck 18 and opposed aligned sections or arms 20 and 22, each of which extend to an associated angled or contra angled member 24 and 26, respectively. Arms 20 and 22 include projections 20a and 22a respectively, dimensioned to limit the extent to which arms 20 and 22 may be folded inwardly toward or against one another, when the arms are inserted into the open end of holder 12. Arm 20 further includes a retention tab 20b and arm 22 includes a retention tab 22b, each of these are dimensioned for insertion and retention into corresponding, opposed apertures 15 and 17, respectively, extending from a hollow bore or region 13 of holder 12, when arms 20 and 22 are pivoted or folded over one another about neck 18.

Attention is now directed to the construction of angled portions 24 and 26. As shown in FIG. 2 each arm is inclined at an angle a, of about 35 degrees, or in the range generally of about 25-50 degrees, relative to the long axis, shown in dashed lines, of arms 20 and 22. This inclination facilitates the doctor's ability to see exactly where the applicator tip is positioned when it is inserted near the posterior teeth in a patient's mouth. Each angled portion is dimensioned similarly overall, but there are important differences. Angled portion 26 includes extensions or pin 26a and post 26b, dimensioned for reception into corresponding aligned apertures 24a and 24b, respectively, in angled portion 24. A stop or limit member is shown at 24c, which is to provide a guide as to the extent of insertion of applicator 16. The retainer may be fabricated or molded of a semi transparent thermoplastic resin.

Rounding out a description of applicator 16, which is the final component, attention is directed to FIG. 5. As shown, applicator 16 is a small block of resilient, absorbent material, which may be formed as an open cell foam insert indicated at 28, and includes a generally rounded or curved or convex end or tip 28a and an inwardly curved opposed end 28b. The applicator may be dimensioned about ½ to 1 inch in length and ¼ to ½ of an inch in width, and about ⅛ to 3/16 of an inch in thickness. The foam is flexible and adapted to be saturated with a conventionally available coolant (subsequent to being held in the retainer). It is readily mounted and firmly gripped by the retainer, which in turn is received in the handle. The assembly of the foam applicator and retainer will now be described.

### Assembly of the Instrument and its Use in Endodontic Diagnostics

The instrument has been designed to provide controlled cold testing of multiple teeth, and its assembly is simple. The applicator and retainer are not contemplated as being reusable, although the holder may be readily sanitized in an autoclave process, for repeated use.

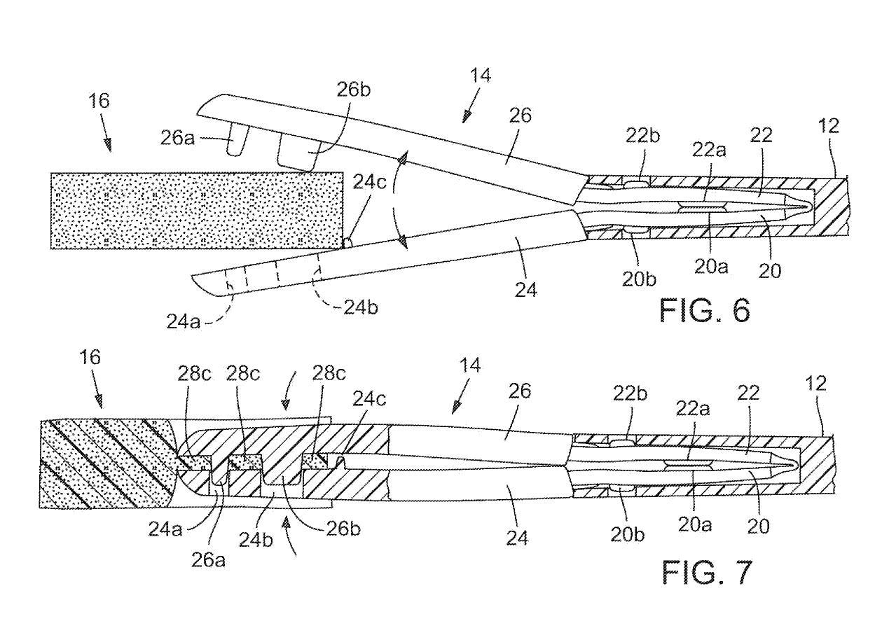

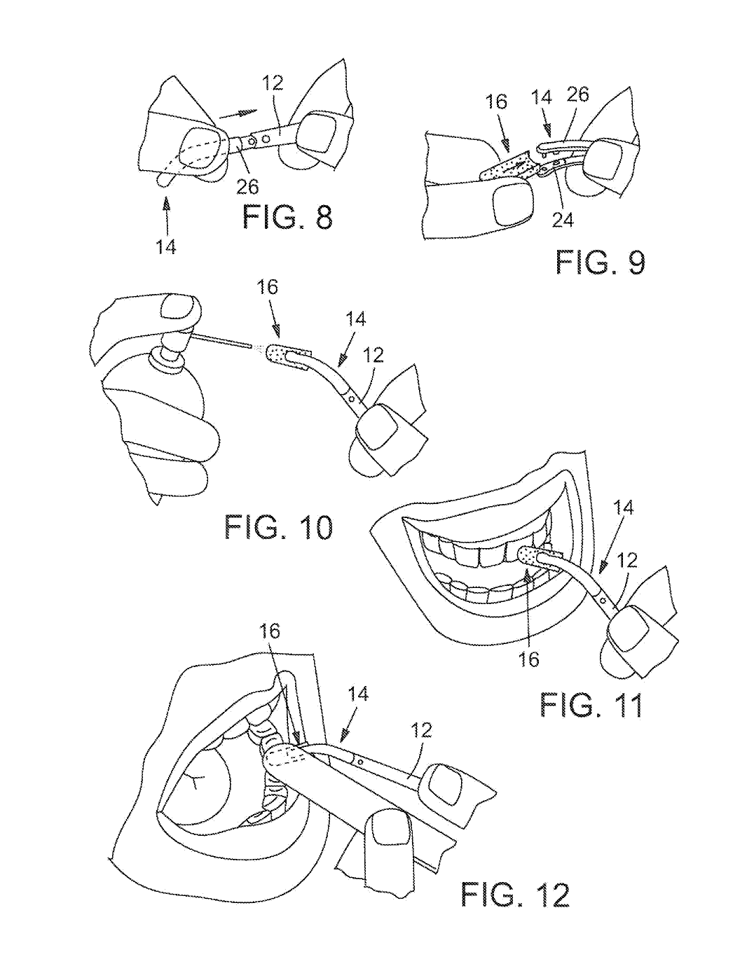

Initially, it is necessary to insert the retainer into the holder, and the steps for assembly are shown in FIGS. 2, 2A, 3 and 6-9. The doctor selects the retainer, such as that shown in FIG. 2, and then bends or folds one portion over the other; for example, as shown in FIG. 2A, where arm 22 has been folded toward and over arm 20, about a fold axis indicated at neck 18. Pivoting about neck 18 continues until a substantially complete fold is provided, as shown in FIG. 3. In this orientation, retainer 14 is now positioned for detachable insertion into holder 12, (see FIG. 8) and may be fully inserted until the retainer is in a secure position, with retention tabs 20b and 22b snapped into reception in apertures 15 and 17, respectively. FIG. 4 shows arms 20 and 22 as they are inserted into the hollow portion, prior to full insertion, when retention tabs 20b and 22b will be inserted in apertures 15 and 17, respectively. Angled portions 24 and 26 are shown slightly spread apart, as they may be, during insertion, but once fully inserted may be positioned more adjacent one another. As shown in FIG. 9 the doctor now spreads apart the arms, in particular angled portions 24 and 26 of retainer 14, and inserts a single foam applicator 16 about half way into the assembly, as shown in FIGS. 6 and 9. Once the block of foam applicator is inserted, the angled arms are squeezed so that pin 26a and post 26b penetrate the foam and angled arms 24 and 26 engage and firmly grip the foam to secure it n place, as shown in FIG. 7. A tip portion of the foam extends outwardly from the retainer, as shown in FIG. 7. The doctor should gently pull on the foam to ensure that it is securely held in place, and some resistance should be felt. As can be seen in FIG. 7, portions of the foam of the applicator tip, although squeezed, are still substantially wide, as shown at 28c to retain coolant. In other words, the foam is not so compressed that it cannot retain coolant, in those portions that are compressed between angled portions 24 and 26.

As shown in FIG. 10, the foam applicator is saturated with a known dental coolant, from a spray can, for example, and the foam will turn to a frosty appearance as it cools. For diagnosing pulpal health, the doctor will apply the chilled foam to tooth structure, and by stimulating the nerve of a tooth, the doctor, through the patient's response, can ascertain which tooth is the sensitive one causing discomfort or pain. This is important because in some situations the patient may misidentify which tooth is the cause of the pain. In these cases, the tooth believed to cause the pain is called the referring site, but the pain really originates from a symptomatic tooth or teeth causing the problem. Use of the diagnostic instrument as described here will quickly and accurately generate a patient response leaving no doubt concerning the identity of the symptomatic tooth.

The use of foam, firmly held and saturated with coolant enables controlled diagnosis by the doctor. Specifically, as the foam advances against a tooth, more cold will be transferred, and the doctor may advance cautiously if needed, until the patient's response clarifies where the pain originates. FIGS. 11 and 12 show how a doctor may apply the applicator tip to teeth of a patient. For teeth located in the posterior portion of a patient's mouth, the angled portions 24 and 26 facilitate the doctor being able to see accurately where the applicator tip is positioned. This is shown to a certain extent in FIG. 12.

Listing of the claims:

1. A hand-held endodontic diagnostic instrument comprising:
an applicator for receiving coolant;
a retainer positionable between a first, open position for receiving the applicator, and a second, closed position for clamping onto the applicator; and
a handle for receiving the retainer.

2. The diagnostic instrument of claim 1 wherein the retainer is an elongate foldable member which is detachable from the handle.

3. The diagnostic instrument of claim 1 wherein the retainer is an elongate member having opposed arms, foldable from a first, open position where the arms are aligned, relative to one another, to a second, closed position where the arms overlap each other.

4. The diagnostic instrument of claim 3 wherein each arm has an angled portion, dimensioned for clamping onto the applicator when the arms are folded to overlap each other.

5. The diagnostic instrument of claim 4 wherein the applicator is formed of resilient, absorbent material, and is dimensioned with a curved tip which extends outwardly from the retainer when the applicator is clamped in the retainer.

6. The diagnostic instrument of claim 5 wherein the handle includes a hollow portion into which the arms of the retainer may be inserted and detachably retained therein.

7. The diagnostic instrument of claim 6 wherein the angled portions of the retainer include portions for gripping the applicator.
